(19) United States
(12) Patent Application Publication
(10) Pub. No.: US 2014/0332465 A1
(43) Pub. Date: Nov. 13, 2014

(54) METHOD AND APPARATUS FOR TREATING OIL CONTAINING WASTEWATER

(71) Applicant: SWING CORPORATION, Tokyo (JP)

(72) Inventors: Masayoshi Kitagawa, Tokyo (JP); Takashi Matsumura, Tokyo (JP); Hirokazu Isozaki, Tokyo (JP); Masahide Suzuki, Tokyo (JP)

(21) Appl. No.: 14/363,678

(22) PCT Filed: Feb. 20, 2013
(86) PCT No.: PCT/JP2013/054169

§ 371 Date: Jun. 6, 2014

(30) Foreign Application Priority Data
Mar. 23, 2012 (JP) 2012-067517

(51) Int. Cl. C02F 9/00; C02F 1/24; C02F 1/00; C02F 3/12

(52) U.S. Cl. CPC C02F 9/00; C02F 3/1268; C02F 3/1263; C02F 1/24; C02F 1/00; C02F 2101/32
USPC 210/620; 210/259

(57) ABSTRACT

It relates to a treatment of oil-containing waste water using a membrane biological reactor membrane biological reactor biological reactor (MBR), and it is to provide a new treatment apparatus which is capable of suppressing a reduction in biological treatment activity and suppressing an effect on a separation membrane.

Provided is a membrane biological reactor having a biological reaction chamber and a membrane separation chamber, in which the it has a configuration that, within the biological reaction chamber, at least one partition is installed to have a first reaction chamber, a second reaction chamber, and if necessary, an additional reaction chamber so as to form an upflow and downflow flow path, an aeration device and a scum/oil skimmer are installed at least in the first reaction chamber, and a mixture liquid containing activated sludge is withdrawn from the membrane separation chamber and distributed and returned at least to the first reaction chamber and the second reaction chamber.

### TECHNICAL FIELD

The present invention relates to a method for treating oil-containing waste water that is generated according to obtainment and production of petroleum oil, coal, natural gas, shale gas, coal bed methane (CBM), oil sand, and shale oil, or oil-containing waste water that is discharged from various plants, for example, oil-containing waste water discharged from a petrochemical plant or an automobile manufacturing plant (taken together, they are referred to as “oil-containing waste water”) and a treating apparatus therefor.

### BACKGROUND OF THE INVENTION

In recent years, in accordance with significant industrial progresses, population increase, and expansion of metropolitan cities in developing countries, needs for energy resources such as petroleum oil and natural gas increase more than ever before all over the world. In addition, due to an accident occurring in an atomic power plant, presently the energy resource has to rely on petroleum oil, coals, and natural gas. Meanwhile, among regions in which petroleum oil, coals, and natural gas are obtained in a great amount, many suffer from shortage of water resource, and thus recycling of oil-containing waste water that is generated according to obtainment and production of them is required. In particular, since there is a tendency that an oil refinery, a petrochemical•coal chemical plant, or the like is located near the region from which energy resources are obtained, water resources required for production, operation, and management are insufficient, and thus nowadays there is no choice but to recycle generated oil-containing waste water. For such reasons, a water treatment technology for obtaining economically and stably the advancedly treated water is waited for.

As an example of water treatment technology for treating waste water, a membrane biological reactor (MBR: membrane bioreactor) is known. The membrane separation activated sludge process (MBR) is a method of obtaining treated water by treating raw water based on biological reaction treatment using activated sludge and performing solid and liquid separation of such treated water using a separation membrane. According to the membrane separation activated sludge process (MBR), membrane filtration is adopted as a means for solid and liquid separation, and thus not only release of turbid components into treated water is prevented but also the activated sludge can be maintained at high concentration. Accordingly, it has advantages that treatment time may be shortened and treatment facilities may be established in compact form.

Regarding the membrane separation activated sludge process, a multi-stage activated sludge treatment apparatus in which conventional reaction chambers for biological treatment are divided and provided in multi-stage form for the purpose of improving water quality of biologically treated water is disclosed in JP 2000-42584 A (Patent Document 1).

In addition, JP 2005-360619 A (Patent Document 2) discloses a biological treatment in which, using a multi-stage biological treatment apparatus, biologically treated water from the first-stage biological treatment reaction chamber is subjected to aggregation treatment and water separated by a means of solid and liquid separation is biologically treated in the second-stage biological treatment reaction chamber.

In addition, JP 2008-264772 A (Patent Document 3) discloses a membrane biological reactor which is provided with an aeration tank, a biological treatment tank divided into two or more levels, and a membrane separation tank that are serially disposed in the direction from the upflow to the downflow, in which the biological treatment tank has a carrier and is provided with a return unit for returning sludge in the membrane separation tank to the biological treatment tank.

It is also suggested to apply the membrane separation activated sludge process (MBR) for treating oil-containing waste water such as waste water from a petrochemical plant or a petroleum oil refining plant.

For example, JP 2011-177607 A (Patent Document 4) suggests oil-containing waste water treatment method including a membrane separation activated sludge treatment process for biologically treating the oil-containing waste water in the activated sludge treatment tank and membrane separating the biologically treated water by a membrane separation device installed in an activated sludge treatment tank.

JP 3900796 B1 (Patent Document 5) discloses a technique including that waste water containing organic solid matters such as fats is separated in advance into solid matters and supernatant in a solid and liquid separation chamber and the solid matters are subjected to a solubilization treatment at high temperature, and the supernatant and treated liquid are subjected to a biological treatment.

JP 2007-029825 A (Patent Document 6) discloses a technique for activated sludge treatment of the water that is treated by electrolytic treatment or flocculation treatment of waste water containing hardly decomposable oils, fats, or the like.

In addition, JP 2009-241058 A (Patent Document 7) discloses, as a waste water treatment method that enables safe application of the membrane separation activated sludge process to industrial waste water from a petrochemical plant or a petroleum oil refinery plant, a waste water treatment method including: a filtering process of filtering the waste water supplied into an activated sludge tank and biologically treated therein, in a membrane module installed outside the activated sludge tank; a chemical cleaning process of chemical cleaning the membrane module with a membrane cleaning agent while the membrane module is disconnected from the activated sludge tank with a valve; and a water flushing process of flushing off the membrane cleaning agent remaining in the membrane module with water while the membrane module and the activated sludge tank are disconnected from each other with the valve, in which the membrane cleaning agent is prevented from contacting substances contained in the waste water that react with the membrane cleaning agent forming hazardous substances or operation biological inhibiting substances.

### CITATION LIST

### Patent Document

Patent Document 1: JP 2000-42584 A

Patent Document 2: JP 2005-360619 A

Patent Document 3: JP 2008-264772 A

Patent Document 4: JP 2011-177607 A

Patent Document 5: JP 3900796 B1

Patent Document 6: JP 2007-029825 A

Patent Document 7: JP 2009-241058 A

Patent Document 8: JP 2009-241058 A

### DISCLOSURE OF THE INVENTION

### Problem to be Solved by the Invention

When oil-containing waste water is treated by using the membrane separation activated sludge process (MBR), the oil components that are adsorbed onto activated sludge, inhibit oxygen supply to the activated sludge, yielding lowered activity. In addition, when the oil components are adsorbed onto a separation membrane, separation performance of the membrane is lowered. Thus, when oil-containing waste water is treated by membrane separation activated sludge process, it is generally subjected to a pre-treatment such as coagulation separation treatment, pressure floatation and separation treatment, and electrolytic treatment and then applied to a membrane biological reactor.

Still, however, oil-containing waste water discharged from a petrochemical plant or petroleum oil refinery plant contains biological inhibiting substance, and hardly decomposing components as well as oil components at greatly fluctuating concentration, thus problems such as unstable removal performance as the biotreatment function of activated sludge is affected by them or difficult solid-liquid separation as the separation membrane is damaged by adsorption of oil components have been observed. Further, when water or clay remained on bottom of an oil storage tank is discharged, for example, if oil and water separation is insufficient or a great amount of oil components is discharged by erroneous operation or the like, it may not be processed by a pre-treatment, and thus there may be a case in which a great amount of oil components is introduced to a membrane biological reactor, yielding stoppage of operation.

Under the circumstances, the present invention relates to a method for treatment of oil-containing waste water using a membrane biological reactor (MBR) and a treatment apparatus therefor. Specifically, provided by the invention is a novel method for treatment of oil-containing waste water, which is useful for suppressing decrease in biological treatment function and a bad effect on separation membrane, and can constantly exhibit stable treatment performance even when a great amount of oil components flows in, and a treatment apparatus therefor.

### Means for Solving Problem

Regarding an apparatus for membrane separation activated sludge process having a biological reaction chamber in which activated sludge is present and a membrane separation chamber, provided by the invention is a membrane biological reactor having a configuration that, within the biological reaction chamber, at least one partition is installed to have a first reaction chamber, a second reaction chamber, and if necessary, an additional reaction chamber so that flow of water to be treated can form upflow and downflow flow path, an aeration device and a scum/oil skimmer are installed at least in the first reaction chamber, and a mixture liquid containing activated sludge is withdrawn from the membrane separation chamber, and distributed and returned at least to the first reaction chamber and the second reaction chamber.

Also provided by the invention is a method for treatment of oil-containing waste water, characterized in that a membrane biological reactor having a biological reaction chamber in which activated sludge is present and a membrane separation chamber, in which the apparatus has a configuration that, within the biological reaction chamber, at least one partition is installed to have a first reaction chamber, a second reaction chamber, and if necessary, an additional reaction chamber so that flow of water to be treated can form upflow and downflow flow path and an aeration device and a scum/oil skimmer are installed at least in the first reaction chamber, is used, the oil-containing waste water is water to be treated that is supplied to the first reaction chamber, oil components and sludge adsorbed onto the oil components are floated up by aeration using the aeration device in the first reaction chamber, the floating components are recovered and removed by the scum/oil skimmer, the water to be treated is sent to a reaction chamber at downflow side and flown as upflow and downflow flow to be introduced into the membrane separation chamber in which the water to be treated is subjected to solid-liquid separation, and the liquid passed through the membrane is discharged while the mixture liquid containing activated sludge not passed through the membrane is collected from the membrane separation chamber, and distributed and returned at least to the first reaction chamber and the second reaction chamber.

### Effect of the Invention

By installing a partition within the biological reaction chamber to have a first reaction chamber, a second reaction chamber, and if necessary, an additional reaction chamber, even when a large amount of oil components or biological inhibiting substances accidentally flows in, the first reaction chamber which receives first the waste water is affected by it and functions as a buffering chamber, and thus the effect on the second reaction chamber and following reaction chambers can be suppressed, yielding a stable operation.

Further, by forming upflow and downflow flow path within the biological reaction chamber, when the water to be treated is formed to be downflow flow, for example, oil components or activated sludge adsorbed with oil components can be separated as they are readily floatable, and the floating components can be excluded by collecting them using a scum/oil skimmer. Therefore, it is possible that the oil components reaching the membrane separation chamber are reduced to suppress the contamination of the membrane by oil components.

Further, by collecting the mixture liquid containing activated sludge from the membrane separation chamber, and distributing and returning not only to the first reaction chamber but also to the second reaction chamber, concentration of the activated sludge can be increased in both the second reaction chamber and other reaction chambers at the downflow side, and therefore microorganism decomposition efficiency can be enhanced. Accordingly, even when a large amount of oil components or biological inhibiting substances accidentally flows in and the activated sludge in the first reaction chamber is damaged, the first reaction chamber is affected by it and functions as a buffering chamber, and thus the treatment in the second reaction chamber and other reaction chambers at the downflow side can be stably performed.

### BRIEF DESCRIPTION OF DRAWINGS

FIG. 1 is a cross sectional view illustrating a constitution of a waste water treatment apparatus that is related to an exemplary embodiment of the invention;

FIG. 2 is a cross sectional view illustrating a variation of the waste water treatment apparatus illustrated in FIG. 1;

FIG. 3 is also a cross sectional view illustrating a variation of the waste water treatment apparatus illustrated in FIG. 1;

FIG. 4 is an enlarged, partial cross sectional view illustrating the enlarged main part of the waste water treatment apparatus of FIG. 3;

FIG. 5 is a cross sectional view illustrating a constitution of a waste water treatment apparatus that is related to an embodiment different from that of FIG. 1, in which (1) represents a top view and (2) represents a cross sectional view;

FIG. 6 is a drawing to illustrate the results of Example 1 and Comparative Example 1;

FIG. 7 is a drawing to illustrate the results of Example 1 and Comparative Example 1;

FIG. 8 is a drawing to illustrate the results of Example 1 and Comparative Example 1;

FIG. 9 is a drawing to illustrate the results of Example 1 and Comparative Example 1; and

FIG. 10 is a drawing to illustrate the results of Example 2.

### BEST MODE(S) FOR CARRYING OUT THE INVENTION

Next, the invention will be described on the basis of the following embodiments, but it is evident that the invention is not limited to the embodiments to be described below.

<Waste Water Treatment Apparatus of the Invention>

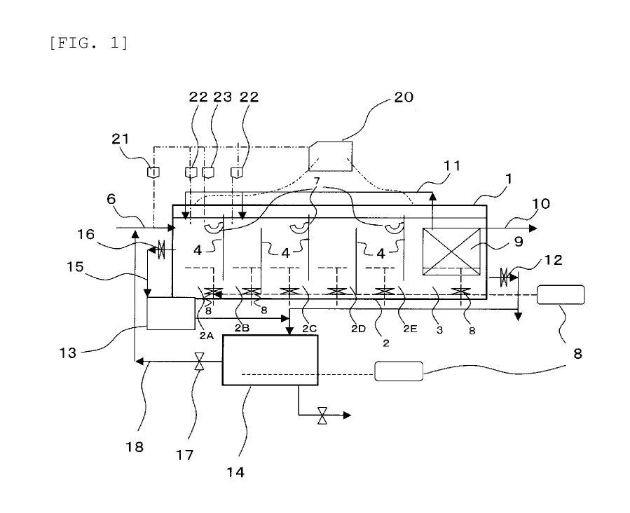

The waste water treatment apparatus of the invention relating to one embodiment of the invention (referred to as “the waste water treatment apparatus of the invention”) includes a membrane separation activated sludge chamber 1 provided with a biological reaction chamber 2 and a separation membrane chamber 3, which is installed to allow a flow from upflow to downflow, that is, a flow direction of water to be treated, in which at least one partition 4 is installed within the biological reaction chamber 2 and at the boundary between the biological reaction chamber 2 and the separation membrane chamber 3 so that the flow of water to be treated forms upflow and downflow flow path and the inside of the biological reaction chamber 2 is divided into a first chamber 2A, a first chamber 2B, and if necessary, additional chambers 2C, 2D, or the like (in FIG. 1, there are five reaction chambers).

Further, the waste water treatment apparatus of the invention is provided with a returning pipe 11 for withdrawing a mixture liquid containing activated sludge from the separation membrane chamber 3, and distributing and returning part of the mixture liquid to a reaction chamber such as the first reaction chamber and the second reaction chamber of the biological reaction chamber 2 and a sludge drain pipe 12 for discharging the other remaining mixture liquid as discharge sludge.

(Water to be Treated)

A waste water supply pipe 6 is connected to the entrance side of the biological reaction chamber 2, that is, entrance side of the first reaction chamber 2A, and it is designed such that oil-containing waste water as water to be treated flows in the first reaction chamber 2A via the waste water supply pipe 6.

As described herein, oil-containing waste water as water to be treated (referred to as “water to be treated”) is only required to be waste water which contains oil components.

Specific examples of a treatment object, that is, water to be treated, may include oil-containing waste water that is generated according to obtainment and production of petroleum oil, coal, natural gas, shale gas, coal bed methane (CBM), oil sand, and shale oil, or oil-containing waste water that is discharged from various plants, for example, oil-containing waste water discharged from a petrochemical plant or an automobile manufacturing plant.

Further, an application can be made also for treatment of waste water discharged from a coal-chemical plant or a cokes manufacturing plant.

In the water to be treated, in addition to components such as an organic substance that is easily decomposed by microorganisms (referred to as a “easily decomposing component”), oil components that are not dissolved in water but float in water, for example, free oil components such as heavy oil component and oil components in which benzene or toluene is partially solubilized are included. Among them, free oils such as heavy oil components are the hardly decomposing components that are difficult to be decomposed by activated sludge (herein below, they are referred to as “hardly decomposing components) and the oil components such as benzene and toluene are the component that can be relatively easily decomposed by microorganisms when suitably acclimated.

Further, when the free oil such as heavy oil components is adsorbed onto a surface of the activated sludge particles, oxygen penetration is suppressed to lower the decomposing activity, and also due to lower specific gravity caused by adsorption of oil components, the particles can float in water.

In the water to be treated according to the invention, it is possible that a biological inhibiting substance such as phenol, cyan, and cresol (herein below, they are referred to as a “biological inhibiting substance”) may be contained, and they may exhibit a biological inhibiting activity when they are present in a higher amount than a certain amount.

(Biological Reaction Chamber)

In the biological reaction chamber 2, activated sludge as a group of various aerobic microorganisms is present. Inside the reaction chamber, at least one partition 4 is installed so that the flow of water to be treated forms upflow and downflow flow path and the inside of the biological reaction chamber 2 is divided into a first chamber 2A, a first chamber 2B, and if necessary, additional chambers 2C, 2D, or the like. The partition 4 is also installed at the boundary between the biological reaction chamber 2 and the separation membrane chamber 3.

The water to be treated (that is, waste water) flown into the first reaction chamber 2A of the biological reaction chamber 2 forms an upflow and downflow flow path and flows through the inside of the biological reaction chamber 2. During the flow process, organic substances or decomposable oil components contained in the waste water are decomposed by activated sludge and flown into the separation membrane chamber 3.

By partitioning the inside of the biological reaction chamber 2 to plural reaction chambers so as to form an upflow and downflow flow path, even when a large amount of oil components or biological inhibiting substances is flown into the biological reaction chamber 2, the first reaction chamber 2A can deal with the resulting effect, and thus the effect on reaction chambers at downflow side can be relieved and the amount of the oil components reaching the separation membrane chamber 3 can be reduced.

From this point of view, it is preferable that the inside of the biological reaction chamber 2 is partitioned into at least three reaction chambers. From the view point of reducing the amount of oil components reaching the separation membrane chamber 3, it is preferable that partitioning is made to have at least 5 reactions chambers.

Size of each reaction chamber may be the same or different from each other. However, since the first reaction chamber 2A functions as a buffering chamber for a case in which a large amount of oil components is introduced, and thus for purpose of enhancing the buffering function, it is preferable that the first reaction chamber 2A is made larger than the reaction chambers 2B, 2C, or the like which follows the second reaction chamber.

The partition 4 may be a partition board, a partition wall, or may have any other form.

The partition 4 is alternately installed at top part and bottom part of the biological reaction chamber 2 so that the water to be treated (that is, waste water) alternately forms an upflow flow path and a downflow flow path within the biological reaction chamber 2.

The partition 4 at top part of the biological reaction chamber 2 is vertically installed such that the top of the partition 4 protrudes above the water surface and the bottom of the partition 4 has a space to the bottom surface of the chamber while both ends are fixed on a side wall of the biological reaction chamber 2.

Meanwhile, the partition 4 at bottom part of the biological reaction chamber 2 is vertically installed such that the top of the partition 4 has a space to the ceiling surface of the chamber and is present under the water surface while the bottom of the partition 4 is fixed on a bottom surface of the biological reaction chamber 2 and both ends are fixed on a side wall of the biological reaction chamber 2.

The water to be treated preferably forms a downflow flow inside the first reaction chamber 2A. When it forms a downflow flow, floating components such as oil components, activated sludge adsorbed with oil components, and scum float up in the downflow flow, and thus those floating components can be efficiently separated and removed.

Thus, to have a downflow flow in the first reaction chamber 2A, alternate installment including that the first partition 4 from the entrance of the biological reaction chamber 2 is installed at top part and the next partition 4 is installed at bottom part may be considered. As a result, alternate upflow and downflow flow path can be created.

Further, since it is desirable to have a downflow flow in the first reaction chamber 2A, the waste water supply pipe 6 is connected to a position which is at least above the middle height of the entrance side wall of the first reaction chamber 2A, preferably to the water surface.

Further, it is also preferable that the reaction chamber at the most downflow side (that is, fifth reaction chamber 2E in FIG. 1), that is, the reaction chamber immediately before the separation membrane chamber 3, has a downflow flow in order to prevent flow-in of the oil components to the separation membrane chamber 3. Accordingly, it is preferable that the partition installed at the most downflow side, that is, the partition 4 installed at boundary between the biological reaction chamber 2 and the separation membrane chamber 3, is installed at top part so that the reaction chamber immediately before it has a downflow flow.

In the first reaction chamber 2A of the biological reaction chamber 2, the scum/oil skimmer 7 and the aeration device 8 are installed. With the aeration device 8, microorganisms of the activated sludge are activated by supplied air/oxygen and the oil components or scum in the water to be treated which has flown into the first reaction chamber 2A, and activated sludge adsorbed with oil components float up, and then collected and removed by the scum/oil skimmer 7.

The scum/oil skimmer 7 is preferably installed on top of the first reaction chamber 2A, that is, near the water surface. As illustrated in FIG. 1, it is preferably installed in width direction such that it is in contact with the partition 7 or very close to but not in contact with the partition 7.

The scum/oil skimmer 7 may be installed in each reaction chamber. However, for efficient separation and removal of the components that float up by having a downflow flow, it is preferably installed in a reaction chamber having a downflow flow (that is, the first reaction chamber 2A, the third reaction chamber 2C, and the fifth reaction chamber 2E in FIG. 1) in the same manner as the first reaction chamber 2A.

By installing the scum/oil skimmer 7 in the first reaction chamber 2A, the third reaction chamber 2C, and the fifth reaction chamber 2E, or the like as described above, the oil components, the activated sludge adsorbed with oil components, the scum or the like that are floated up by air/oxygen supplied by the aeration device 8 can be collected and removed by the scum/oil skimmer 7, and thus the flow-in of the oil components to the separation membrane chamber 3 can be prevented.

The aeration device 8 is a device for generating bubbles of air/oxygen to be supplied to the activated sludge. It is preferably installed not only in the first reaction chamber 2A but also at bottom part of the second reaction chamber 2B and each of the reaction chambers 2C, 2D, or the like that are present at the downflow side.

When the aeration device 8 in installed in each reaction chamber, it is preferable that each aeration device 8 is connected with a pipe for supplying air/oxygen as illustrated in FIG. 1.

(Separation Membrane Chamber)

Within the separation membrane chamber 3, an submerced membrane unit 9, a treated water drain pipe 10, a returning pipe 11, and a sludge drain pipe 12 are installed.

The water to be treated which has flown in from the biological reaction chamber 2 (that is, the fifth reaction chamber 2E in FIG. 1) is subjected to solid-liquid separation by the submerced membrane unit 9 and the treated water passed through the separation membrane is discharged via the treated water drain pipe 10. Also a mixture liquid containing residual components (including activated sludge), that is, a mixture liquid present immediately before (that is, upflow side) the submerced membrane unit 9 in the separation membrane chamber 3, is returned to the biological reaction chamber 2 via the returning pipe 11 while part of the mixture liquid is discharged via the sludge drain pipe 12 at appropriate time point.

The submerced membrane unit 9 is prepared as a unit with enlarged area by integration of separation membranes. The submerced membrane unit 9 is installed in an impregnated state in the separation membrane chamber 3, and preferably has a configuration which allows continuous membrane filtration with an aid of an aspiration pump.

Further, as illustrated in FIG. 1, to supply air bubbles to the submerced membrane unit 9, it is preferable that the aeration device 8 is installed at bottom part of the separation membrane chamber 3 or an air diffusing device for supplying air bubbles is installed in each submerced membrane unit.

Examples of the separation membrane of the submerced membrane unit 9 include a microfiltration membrane (that is, MF membrane), an ultrafiltration membrane (that is, UF membrane), or the like, but not limited thereto.

Membrane shape may be any one of a plain, hollow fiber, tubular, and monolithic. Material of the membrane may be either an organic substance such as PVDF, PE, PAN, and CA or an inorganic substance such as ceramic and metal.

The sludge drain pipe 12 is preferably provided with an opening and closing device such as a valve.

A unit for washing the submerced membrane unit 9 may be also installed.

For example, by connecting a backwash pipe equipped with a backwash pump in the submerced membrane unit 9, the submerced membrane unit 9 can be backwashed with water treated by membrane filtration.

Further, a design can be made such that washing is carried out according to an intermittent aspiration and filtration mode or an intermittent aspiration and back wash mode.

Still further, the submerced membrane unit 9 may be designed to receive washing with water or washing with chemicals.

(Returning)

In the separation membrane chamber 3, the returning pipe 11 is installed. The mixture liquid containing activated sludge in the separation membrane chamber 3 is withdrawn via the returning pipe 11, and then distributed and returned at least to the first reaction chamber 2A and the second reaction chamber 2B of the biological reaction chamber 2. It is also possible that, if necessary, the mixture liquid is distributed further to the reaction chambers 2C, 2D, or the like at downflow side of the reaction chamber 2B in addition to the first reaction chamber 2A and the second reaction chamber 2B.

Since the activated sludge in the biological reaction chamber 2 flows from upflow to downflow together with the waste water, naturally the concentration of the activated sludge decreases in the biological reaction chamber 2. In this regard, by collecting the mixture liquid from the separation membrane chamber 3 followed by additionally distributing and returning to the first reaction chamber 2A and the second reaction chamber 2B of the biological reaction chamber 2, and if necessary, to reaction chambers at downflow side, the concentration of the activated sludge can be maintained in the biological reaction chamber 2.

At that time, by distributing and returning to the first reaction chamber 2A and the second reaction chamber 2B, and if necessary, also to reaction chambers at downflow side, the concentration of the activated sludge after the second reaction chamber 2B can be increased. Thus, even when the activated sludge in first reaction chamber 2A is damaged due to flow-in of a great amount of oil components or biological inhibiting substances, the decomposition treatment can be performed with the activated sludge present in the second reaction chamber 2B and the reaction chambers at the downflow side, and thus the biological reaction treatment can be performed stably.

In the returned mixture liquid, activated sludge, microorganisms with lost activity, decomposed materials that are decomposed by activated sludge, waste water components that are not decomposed by activated sludge, or the like are included.

Further, a means for returning the activated sludge is not particularly limited, and any common sludge pump can be used.

Still further, by using a flow amount controlling device for controlling the return amount, the return amount from the separation membrane chamber 3 to the biological reaction chamber 2 can be controlled.

(Automatic Control Device)

When the mixture liquid present in the separation membrane chamber 3 is distributed and returned to the first reaction chamber 2A and the second reaction chamber 2B, and if necessary, to reaction chambers at downflow side, the return amount and ratio of distribution (that is, distribution ratio) to each reaction chamber can be controlled by using an automatic control device 20.

With regard to the control of distribution ratio to each reaction chamber, the control can be made by installing a measuring device 21 for measuring concentration of oil components or concentration of biological inhibiting substance in water to be treated (that is, waste water) which flows in the waste water supply pipe 6 and can be adjusted by the number illustrated by the measuring device. For example, when phenols as a biological inhibiting substance are contained, the distribution ratio can be controlled by obtaining relation between phenol concentration and malodor concentration and can be controlled by the value of the malodor concentration.

It is also possible that the respiration rate of the water to be treated in the first reaction chamber 2A (that is, oxygen consumption rate per weight of sludge) is regularly measured by using a measuring device 22, and when the value is significantly lowered compared to previous value, control is made with the automatic control device 20 such as a computer or a sequencer which orders a change in amount or ratio of the mixture liquid returned to the first reaction chamber 2A.

Specifically, since the concentration of organic substances present in flow-in water fluctuates, when the respiration rate is lowered by 25% or more than the rate of previous measurement, a control can be made to increase the return amount to the first reaction chamber 2A. After that, if the respiration rate is further lowered at the next measurement, the return amount to the first reaction chamber 2A is further increased, and once it appears to recover to the initial value, a setting can be made so as to maintain it in the same amount for a while and gradually decrease the return amount.

The setting and time interval for measurement may be arbitrarily determined by using the automatic control device 20.

Further, in order to obtain the respiration rate, a sludge concentration meter 23 and an oxygen concentration meter are required.

The oxygen concentration measurement can be made by collecting a certain amount of water to be treated present in the first reaction chamber 2A in a sample bottle and performing fractionally the reading of a time dependent change in the oxygen concentration. The time dependent change in oxygen concentration can be also obtained by measuring, using an oxygen concentration meter, the oxygen concentration at entrance and exit of the pipe through which the water flows in a constant flow amount and by dividing the concentration with the retention time in the pipe.

Meanwhile, concentration of the sludge can be obtained by impregnating the sludge concentration meter 23 in a reaction chamber.

When there is a possibility of having an error due to fouling of measuring device with oil components or the like, it is also possible that the sludge concentration in the returned mixture liquid is measured and the calculation is made based on the measured flow amount including the returned flow amount and flow-in amount to the first reaction chamber 2A.

It is also possible that, by having measurement value of the respiration rate for the second reaction chamber 2B and controlling the return amount to the first reaction chamber 2A by utilizing a change in the measured value, the return amount can be controlled with high accuracy even when poisonous materials or oil components flow in.

(Storage Chamber•Storage and Activation Chamber)

As illustrated in FIG. 1, it is possible that the storage chamber 13 and the storage and activation chamber 14 are installed separately from the membrane separation activated sludge chamber 1, a water drain pipe 15 and a valve 16 are installed in the first reaction chamber 2A, the waste water is discharged from the first reaction chamber 2A via the water drain pipe 15 by opening the value 16, and the discharged waste water is first stored in the storage chamber 13 and supplied to the storage and activation chamber 14 for activating microorganisms therein.

When the waste water is withdrawn from the first reaction chamber 2A by opening the valve 16, the flow amount in the second reaction chamber 2B can be lowered and the amount of oil components or biological inhibiting substances which have been introduced to the first reaction chamber 2A and then flow in the second reaction chamber 2B or downflow thereof can be lowered.

At that time, instead of directly sending the waste water withdrawn from the first reaction chamber 2A to the storage and activation chamber 14, by holding first it in the storage chamber 13, abrupt flow-in of contaminated sludge or the like to the storage and activation chamber 14 can be prevented.

As the storage and activation chamber 14 is provided with an aeration device, the activated sludge stored in the chamber can be activated by it, and according to opening and closing of the valve 17, the stored liquid in the storage and activation chamber 14 can be brought back to the first reaction chamber 2A via the water supply pipe 18.

At that time, it is preferable that the microorganisms are activated by performing aeration with retention time of at least 10 min in the storage and activation chamber 14.

As explained in the above, when the respiration rate is found to be lowered more than the setting value when the respiration rate of the water to be treated in the first reaction chamber 2A is measured by using the measurement device 22 or the like, the stored liquid in the storage and activation chamber 14 may be brought back to the first reaction chamber 2A via the water supply pipe 18. By doing so, for a case in which a great amount of oil components or biological inhibiting components flows in, the activated sludge accumulated in the storage and activation chamber 14 is supplied to the first reaction chamber 2A and most of the oil components or the biological inhibiting components are attached or absorbed onto the activated sludge supplied to the first reaction chamber 2A. As a result, the decomposition inhibition by activated sludge in a reaction chamber present after the first reaction chamber 2A can be suppressed.

Further, as illustrated in FIG. 1, it is also possible to have the following configuration: the sludge drain pipe 12 is connected to the storage and activation chamber 14 so that the liquid mixture withdrawn from the separation membrane chamber 3 is supplied to the storage and activation chamber 14, in which the sludge is activated.

Further, although not illustrated, it is also possible that scum/oil skimmer 7 is connected to the storage and activation chamber 14 via a water passage pipe and the components collected by the scum/oil skimmer 7 are activated in the storage and activation chamber 14.

<Method for Treatment of Waste Water>

By using the waste water treatment apparatus of the invention with the configuration described above, oil-containing waste water can be treated as follows (the corresponding method is referred to as a “waste water treatment method of the invention”).

However, the apparatus used is not limited to the waste water treatment apparatus of the invention described above.

According to the waste water treatment method of the invention, oil-containing waste water is supplied to the first reaction chamber 2A, oil components and sludge adsorbed onto the oil components are floated up by aeration with the aeration device 8 in the first reaction chamber 2A, the floating components and sludge adsorbed onto the oil components are recovered and removed by the scum/oil skimmer 7, the remaining waste water is supplied to the second reaction chamber 2B and then subjected to solid and liquid separation in the separation membrane chamber 3 to discharge a treated and separated liquid, and the mixture liquid containing the separated solid matters is withdrawn from the separation membrane chamber 3 and then distributed and returned at least to the first reaction chamber 2A and the second reaction chamber 2B for treatment of oil-containing waste water.

As described above, by having plural reaction chambers in the biological reaction chamber 2, even when a large amount of oil components or biological inhibiting substances accidentally flows in, the first reaction chamber 2A which receives first the waste water functions as a buffering chamber, and thus the effect on the second reaction chamber 2B and following reaction chambers can be suppressed.

Further, by forming an upflow and downflow flow path within the biological reaction chamber 2, readily floatable components can be efficiently separated, and since the floating components can be removed by collecting them using the scum/oil skimmer 7, the oil components reaching the membrane separation chamber 3 can be reduced to suppress the contamination of the membrane by oil components.

Further, by collecting the mixture liquid containing activated sludge from the membrane separation chamber 3 and distributing and returning not only to the first reaction chamber 2A but also to the second reaction chamber 2B, and if necessary an additional reaction chamber at downflow side, concentration of activated sludge can be increased in both the second reaction chamber 2B and other reaction chambers at the downflow side, and therefore overall decomposition efficiency of the apparatus can be improved.

Further, it is also possible that, before adding water to be treated (that is, oil-containing waste water) to the first reaction chamber 2A, the water to be treated is subjected to a pre-treatment like coagulation separation treatment, pressure floatation and separation treatment, and electrolytic treatment and then allowed to flow into the first reaction chamber 2A.

The water to be treated which has been flown from the biological reaction chamber 2 (that is, the fifth reaction chamber 2E in FIG. 1) into the separation membrane chamber 3 is subjected to solid and liquid separation by the submerced membrane unit 9, and the liquid passed through the separation membrane is discharged via the treated water drain pipe 10 while the mixture liquid containing residual components of the separation membrane chamber 3 (including activated sludge), that is, a mixture liquid present immediately before (that is, upflow side) the submerced membrane unit 9 in the separation membrane chamber 3, is returned to the biological reaction chamber 2 via the returning pipe 11 while the remaining mixture liquid is discharged via the sludge drain pipe 12 either regularly or at appropriate time point.

(Control of Return Amount)

For distributing and returning the mixture liquid present in the separation membrane chamber 3 back to the first reaction chamber 2A and the second reaction chamber 2B of the biological reaction chamber 2, and if necessary an additional reaction chambers at downflow side, it is possible that a device for measuring regularly the respiration rate of the water to be treated in the first reaction chamber 2A (that is, oxygen consumption rate per weight of sludge) is installed and the amount and total amount of the mixture liquid returned to the first reaction chamber 2A is increased when the value is lower compared to previous value.

Specifically, as the concentration of organic substances vary in flow-in water, the control is preferably made to increase the amount returned to the first reaction chamber 2A when the respiration rate value is lowered by 25% or more than the previous measurement value.

In addition, if the respiration rate continues to get lowered according to the following measurement, the amount returned to the first reaction chamber 2A can be increased. On the other hand, if the value appears to be back to the initial value, the amount is maintained at the same level for a while and a setting for reducing the flow amount is performed.

The setting and time interval for measurement may be arbitrarily determined by using a control system.

By obtaining a respiration rate measurement value from the second reaction chamber 2B and controlling the amount returned to the first reaction chamber 2A by using a change in the measurement value, the return amount can be controlled with high accuracy even when poisonous materials or oil components flow in.

Further, when the respiration rate is lowered more than a pre-determined value, it is possible that the stored liquid containing the activated sludge is additionally sent from the storage and activation chamber 14 to the first reaction chamber 2A.

(Distribution Control)

For distributing and returning the mixture liquid present in the separation membrane chamber 3 back to the first reaction chamber 2A and the second reaction chamber 2B of the biological reaction chamber 2, and if necessary an additional reaction chamber at downflow side, distribution into each reaction chamber may be achieved by using an individual pump therefor. It is also possible that a reservoir wall is installed and the height of the reservoir wall is adjusted. It is also possible that the opening level of the valves installed at pipes is adjusted.

Distribution ratio for each reaction chamber can be arbitrarily set.

However, considering that BOD within the second reaction chamber 2B is lowered compared to the BOD in the first reaction chamber 2A while concentration of hardly decomposing components increases, it is preferable to have higher amount of a mixture liquid returned to the second reaction chamber 2B compared to the amount of a mixture liquid returned to the first reaction chamber 2A.

Specifically, when BOD load of flow-in water compared to the total sludge in reaction chamber is 0.15 kg-BOD/kg-VSS/day or less, for example, the ratio between the amount of a mixture liquid returned to the first reaction chamber 2A and the amount of a mixture liquid returned to the second reaction chamber 2B preferably has the distribution ratio range of from 1:1 to 1:10. More preferably, it has the distribution ratio range of from 1:3 to 1:10.

Meanwhile, when the oil components or biological inhibiting components are included in the waste water at significantly higher concentration than the designed value, in order to increase the amount of mixture liquid returned to the first reaction chamber, it is necessary to increase the amount of the mixture liquid returned via the returning pipe 11, and the distribution ratio is preferably adjusted within the range of from 1:1 to 5:1.

Regarding the modification of the distribution ratio, the distribution ratio can be adjusted by obtaining the relationship between the concentration of oil components or concentration of phenol in flow-in water and concentration of malodor components and determining it based on the concentration of malodor components.

(Method for Dealing with Accidental Cases)

When a large amount of oil components or biological inhibiting substances flows in the first reaction chamber 2A, by promoting floatation of the oil components to top part of the first reaction chamber 2A by stopping or weakening the aeration in the first reaction chamber 2A, collection and removal by the scum/oil skimmer 7 can be promoted. By doing so, the amount of the oil components or biological inhibiting substances which flow in the second reaction chamber 2B or the reaction chambers at downflow side can be lowered and also the decomposition of organic substances can be made by a mixture liquid returned to the second reaction chamber 2B. As a result, a stable treatment can be achieved.

Further, even when an excessively large amount of oil components or the like accidentally flows into the first reaction chamber 2A, it is possible that the water to be treated within the first reaction chamber 2A (that is, waste water) is discharged via the water drain pipe 15 and then stored for a while in the storage chamber 13 and supplied to the storage and activation chamber 14 in which the sludge is activated, and then the stored liquid containing the activated sludge which has been activated within the stored liquid in the storage and activation chamber 14 is added to the first reaction chamber 2A via the water supply pipe 18.

By withdrawing the waste water from the first reaction chamber 2A, the flow amount in the second reaction chamber 2B can be lowered so that not only the flow amount of the adsorbed oil components or biological inhibiting substances in the reaction chambers following the second reaction chamber 2B can be lowered but also it can be brought back to the first reaction chamber 2A after the load to microorganisms is reduced in accordance with decomposition of the oil components or the like. Consequently, the effect on the reaction chambers present at the downflow side can be mitigated.

In addition, by storing the recovered liquid collected by the scum/oil skimmer 7 in a tank (not illustrated) which is separately installed from the membrane separation activated sludge chamber 1 and also by performing a continuous/intermittent aeration treatment, the adsorbed oil or biological inhibiting substances are decomposed for a sufficient time and then stored in the tank, and then they can be brought back to the first reaction chamber 2A or the second reaction chamber 2B when the adsorbed oil or biological inhibiting substance is accidentally added into the biological reaction chamber 2.

The oil-containing waste water as water to be treated by the waste water treatment method of the invention may contain a great amount of nitrogen components. For such case, an operation for removing nitrogen can be carried out by having weak aeration in the first reaction chamber 2A and returning the mixture liquid from the separation membrane chamber 3, for example. Specifically, by having an environment with less oxygen, the microorganisms are forced to receive the oxygen of nitrogen oxides like NO₂ and NO₃, and as a result, the denitrification can be achieved by converting them into nitrogen gas (N₂).

(Washing Method)

The submerced membrane unit 9 and the separation membrane therefor in the separation membrane chamber 3 hardly exhibit any membrane clogging, and therefore it is not required to perform constantly the membrane washing. However, it is desirable to wash it appropriately according to an intermittent aspiration and filtration mode or an intermittent aspiration and back wash mode.

For example, when membrane clogging occurs, it is desirable that the membrane is washed by in-line washing or off-line washing.

As for the method of washing the separation membrane, washing with water or washing with chemicals can be used. Examples of the chemicals that can be used include caustic soda, sodium hypochlorite, hydrochloric acid, and citric acid.

Meanwhile, since the flux property of the separation membrane is slowly deteriorated, it is desirable to perform every few months the chemical washing of the separation membrane. At that time, by having only the separation membrane chamber 3 with a configuration in which it can be closed against previous-stage reaction chamber using a valve or a gate, the washing can be easily performed in on-site manner. Specifically, it is possible that the mixture liquid to the separation membrane chamber 3 is allowed to flow through a connection part having a valve or a gate, the connection part is closed, and then the membrane washing is carried out.

### Second Embodiment

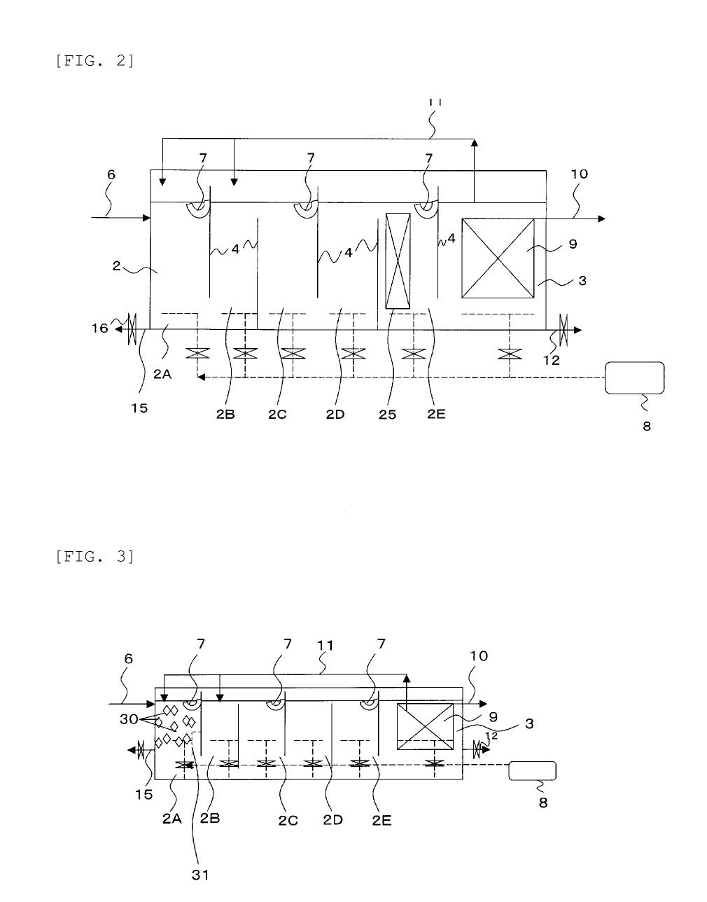

FIG. 2 is a drawing which illustrates a variation of the waste water treatment apparatus illustrated in FIG. 1, characterized in that an adsorption carrier fixing part 25 is installed within the biological reaction chamber 2.

The adsorption carrier fixing part 25 is obtained by fixing and disposing a carrier capable of adsorbing hardly decomposing components.

Examples of the carrier capable of adsorbing hardly decomposing components include activated carbon, various plastic carriers, and sponge carriers. Among them, from the view point of easy adsorption of microorganisms, fibrous activated carbon and particle activated carbon are particularly preferable. Although it is not a carrier which selectively adsorbs hardly decomposing components, it may be any carrier if it can adsorb hardly decomposing components, and it is not limited to the above examples.

Further, as a means for fixing the carrier, it may be fixed by adding the carrier into a mesh basket. However, any means for fixing can be used.

In the biological reaction chamber 2, the waste water flows from the entrance side into the separation membrane chamber 3, and as easily decomposing components are decomposed during the process by the microorganisms, the amount of the easily decomposing components is lowered while concentration of the relatively hardly decomposing components is increased toward the downflow side. For such reasons, in the biological reaction chamber 2, when the adsorption carrier fixing part 25 is possibly installed in a reaction chamber at downflow side, that is, the reaction chamber immediately before the separation membrane chamber 3 (fifth reaction chamber 2E in FIG. 2), not only the hardly decomposing components but also the microorganisms are gradually adsorbed and accumulated on the carrier. Further, as the hardly decomposing components mainly consist of the organic substance remaining near the microorganisms, presence ratio of the microorganisms capable of selectively decomposing hardly decomposing components is increased, and thus the hardly decomposing components can be decomposed by them.

At that time, as there is almost no easily decomposing component, the organisms attached with adsorption carrier can be stably maintained without having an increasing volume.

For such reasons, although the adsorption carrier fixing part 25 may be installed in any reaction chamber of the biological reaction chamber 2, it is preferably installed in a reaction chamber at downflow side, in particular in a reaction chamber at front stage of the separation membrane chamber 3 (fifth reaction chamber 2E in FIG. 2).

### Third Embodiment

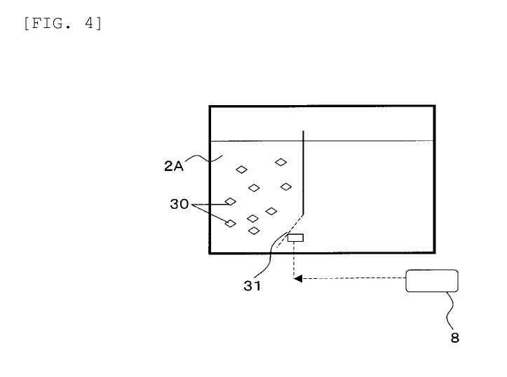

FIG. 3 is a drawing for illustrating a variation of the waste water treatment apparatus illustrated in FIG. 1, and it is characterized in that a hydrophobic carrier 30 is added and floated in the first reaction chamber 2A and, as illustrated in FIG. 4, a screen 31 is installed at lower connection part between the first reaction chamber 2A and the second reaction chamber 2B.

Since the oil components flown with the waste water into the first reaction chamber 2A is adsorbed and concentrated by the hydrophobic carrier 30 and also decomposed by neighboring activated sludge, they are generally floating in much lower concentration state than the oil component adsorption capacity of the hydrophobic carrier 30. However, when concentration of the oil components is accidentally increased in the flow-in water, as they are adsorbed onto the hydrophobic carrier 30, the amount of the oil components flown into the second reaction chamber 2B can be suppressed. Once the concentration of the oil components in water flown into the first reaction chamber 2A is lowered to original normal value, the oil components adsorbed onto the hydrophobic carrier 30 are solubilized and decomposed by neighboring activated sludge. Thus, the oil adsorption amount of the hydrophobic carrier 30 is lowered, and it can have an additional capacity for adsorption of oil components.

As for the hydrophobic carrier 30, any material can be used if it has an activity of adsorbing oil. For example, those having an affinity for hydrocarbon compounds like oil components, e.g., polyethylene (PE) and polypropylene (PP), are preferred most. Those carriers may be used after mixed with short fibers or as an agglomerate after the cross sections of the carriers are fused by melting or prepared in sponge shape. Among them, those formed densely to have higher hydrocarbon adsorption amount are preferable.

Since the material of the hydrophobic carrier 30 generally has weak adherence to microorganisms, only a small amount of microorganisms are adhered and propagate on the carrier. However, if a hydrophilic fabric is bonded or blending with a hydrophobic fabric, a greater amount of microorganisms can be adhered onto the carrier. For example, by mixing or adhering hydrophilic materials like cotton or rayon having many OH basis with a hydrophobic material, a large amount of microorganisms can be adhered onto the carrier. For such case, the oil components adsorbed onto the hydrophobic material can be more effectively decomposed by the microorganisms which have been adhered and propagate on the carrier.

The hydrophobic carrier 30 is required to have a size and a shape which does not allow any release from the screen, and the size is preferably between 3 mm and 10 mm, for example. When the hydrophobic carrier 30 has extremely tiny size, a problem like screen clogging may occur, and thus those having diameter or single side of 2 mm or less are not practically useful.

Specific gravity of the hydrophobic carrier 30 is preferably between 0.9 and 1.1. From the view point of maintaining fluidity, it is preferably between 0.95 and 1.03.

The screen 31 is required to have a smaller mesh size than the hydrophobic carrier 30 so that the hydrophobic carrier 30 cannot flow into the second reaction chamber 2B.

Further, to prevent clogging of the screen 31 as a result of compressing the screen 31 by the hydrophobic carrier 30 along with the flow, if aeration is carried out toward top part of the first reaction chamber 2A side after the screen 31 is placed close to the first reaction chamber 2A and an air diffusing device is installed in the bottom part of the screen 31 at the second reaction chamber 2B side, movement of the hydrophobic carrier 30 is created in top part of the first reaction chamber 2A so that the clogging can be prevented.

### Fourth Embodiment

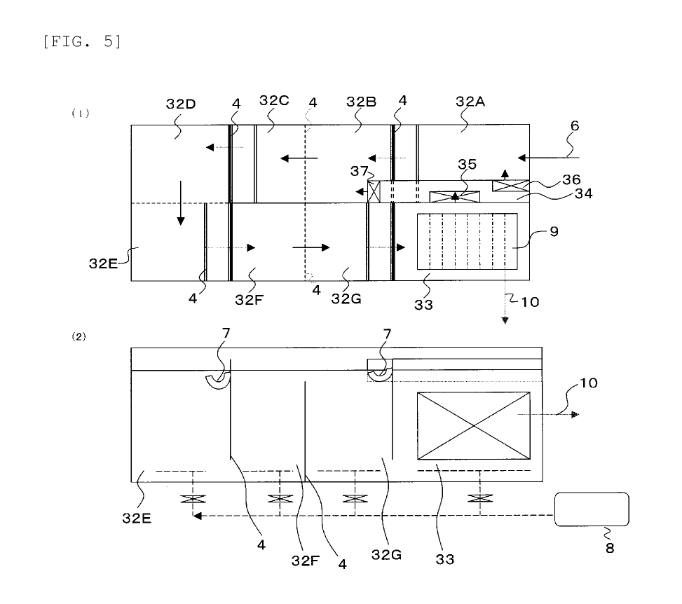

FIG. 5(1) and (2) are a drawing for illustrating a variation of the waste water treatment apparatus illustrated in FIG. 1, and it is characterized in that the first reaction chamber 32A and the second reaction chamber 32B that are divided by the partition 4, and also the reaction chambers 32C, 32D, 32E, 32F, and 32G at the downflow side and the separation membrane chamber 33 are not installed in a single row but installed in two rows after folding and overlapping, a distribution chamber 34 is installed between the separation membrane chamber 33 and the first reaction chamber 32A, a gate 35 is installed for connecting the separation membrane chamber 33 to the distribution chamber 34, a gate 36 is installed for connecting the distribution chamber 34 to the first reaction chamber 32A, and a gate 37 is installed for connecting the distribution chamber 34 to the second reaction chamber 32B.

The waste water flown into the first reaction chamber 32A flows, while moving as a flow path both up and down the chamber, from the first reaction chamber 32A and the second reaction chamber 32B, and also the reaction chambers 32C, 32D, 32E, 32F, and 32G at the downflow side into the separation membrane chamber 33, and after solid and liquid separation by the submerced membrane unit 9 of the separation membrane chamber 33, a clear and transparent filtrate liquid is discharged as treated water while the mixture liquid in the separation membrane chamber 33 containing the separation residuals flows into the distribution chamber 34 via the gate 35 with an aid of air lift caused by aeration in the separation membrane chamber 33, and then, via the gate 36 and the gate 37, distributed and returned from the distribution chamber 34 to the first reaction chamber 32A and the second reaction chamber 32B.

At that time, the amount of the mixture liquid in the separation membrane chamber 33 that is returned to the first reaction chamber 32A and the second reaction chamber 32B can be controlled by adjusting the aeration amount in the separation membrane chamber 33 and opening level of the gate 35.

Further, the distribution for returning to the first reaction chamber 32A and the second reaction chamber 32B can be controlled by adjusting the opening level of the gate 36 and the gate 37.

As described above, according to the waste water treatment apparatus of this embodiment of the invention, the mixture liquid in the separation membrane chamber 33 can be returned to the first reaction chamber 32A and the second reaction chamber 32B by utilizing aeration in the separation membrane chamber 33, and thus the returning can be simply achieved even without using a returning pump. Accordingly, power required for the returning can be saved and the overall size of the apparatus can be reduced.

Further, when the aeration amount in the first reaction chamber 2A and the second reaction chamber 2B is lowered to the level at which the sludge is just maintained without precipitation, a nitrification and denitrification operation can be easily performed.

### Examples

Herein below, the invention is explained in greater detail in view of the following Examples and Comparative Examples.

### Example 1

### Comparative Example 1

Two series of a water chamber (actual reaction chamber volume: 7 L) were prepared. In the series of the invention (Example 1), five pieces of partition were installed in the water chamber so as to have upside and downside flow path in the chamber and six reaction chambers (the first reaction chamber, the second reaction chamber, . . . the fifth reaction chamber, and separation membrane chamber), while an submerced membrane unit is installed in the separation membrane chamber at the most downflow side to give a MBR treatment chamber. Further, it was designed to distribute and return the mixture liquid in the separation membrane chamber to the first reaction chamber and the second reaction chamber at ratio of 20 L/d and 100 L/d, respectively.

Meanwhile, in the comparison series (Comparative Example 1), no partition was installed in the chamber to have a full-mixing chamber and an submerced membrane unit was installed on the opposite side of the entrance for water to be treated. Further, as the comparison series (Comparative Example 1) is a full-mixing chamber, no returning was made.

For both the series of the invention (Example 1) and the comparison series (Comparative Example 1), an submerced membrane unit consisting of 150 mm long hollow fiber membrane (membrane area: 1700 cm) was installed as an submerced membrane unit. For acclimation, sludge was fractionally cultured in raw water containing a certain amount of phenol added to oil-containing waste water and then a continuous treatment was performed with flow amount of 35 L/d. Further, to maintain MISS concentration of 7500 to 8800 mg/L at terminal part, the discharge sludge was withdrawn from the terminal part of the reaction chamber once every two days in an amount of 500 mL.

TABLE 1

| Water quality | Raw water |
|---|---|
| pH (—) | 8.6 |
| SS (mg/L) | 43 |
| CODcr (mg/L) | 525 |
| BOD (mg/L) | 175 |
| Oil (mg/L) | 32 |
| Phenol (mg/L) | 20 |

For Run 1, raw water having the concentration as adjusted to that described in Table 1 was added from the Day 1 to the Day 14.

The raw water includes organic acids and alcohols having good biologically decomposable activity as well as relatively hardly decomposing oil components and phenols having biological inhibiting activity.

From the evening of the Day 14 to the Day 18, a separately prepared mixture liquid containing oils and phenol was added and the operation was performed while their addition concentrations are increased by approximately 1.5 times (Run 2).

Thereafter, water was run until the Day 25 after the concentration is brought back to the initial value (Run 3). From the evening of the Day 25 to the Day 27, the concentration was again increased by 2.5 times (Run 4). Thereafter, the concentration was brought back to the initial value (Run 5).

In addition, for Run 4, 10 L of the sludge of the series of the invention which had been prepared in advance was intermittently added to the first reaction chamber 2A at the rate of 5 L/d under aeration. At the same time, by using a pump, same amount of the mixture liquid was withdrawn from the top layer part and middle part of the first reaction chamber 2A.

(Result)

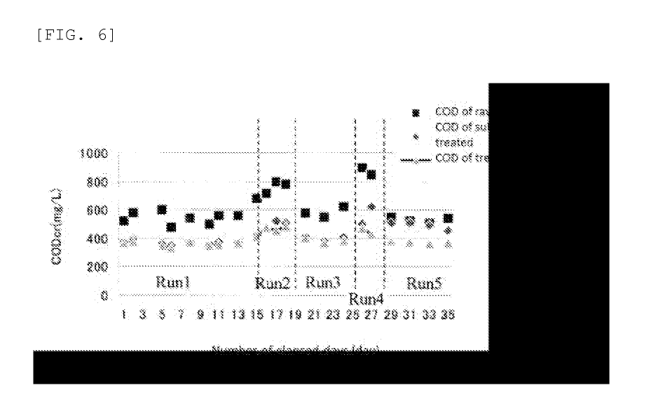

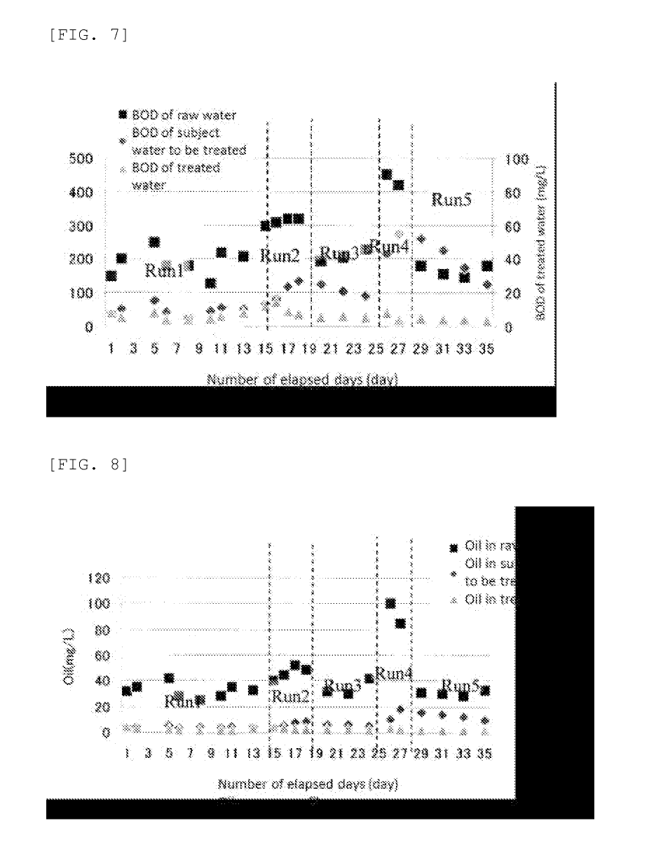

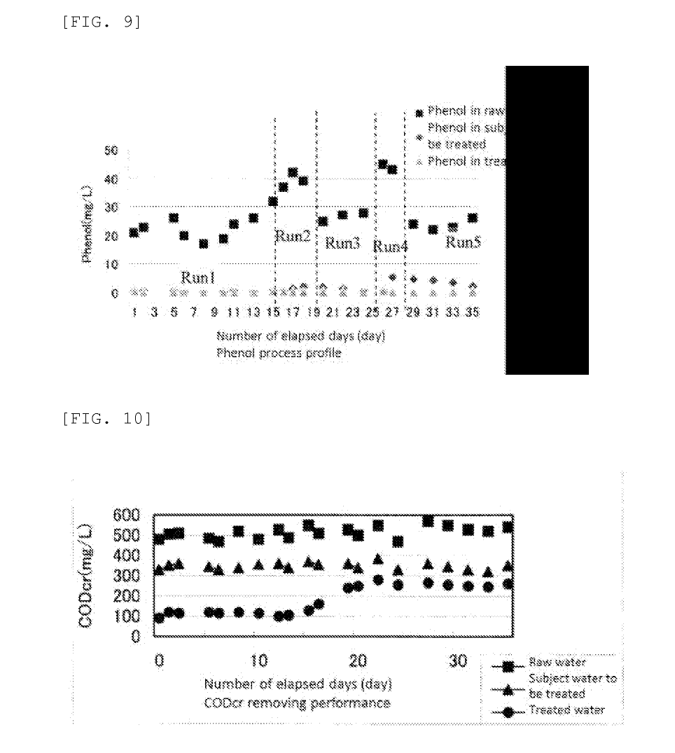

Results obtained from analysis of the raw water, the raw water of comparison series (Comparative Example 1) and series of the invention (Example 1), and the treated water after membrane filtration with respect to water quality including CODcr, BOD, oil components, and phenol are given in FIG. 6 to FIG. 9.

(Discussion)

For Run 1, both series were also operated under low BOD sludge load condition of 0.13 kg/(kg-MISS·day). In any cases, favorable treatment results were obtained stably. The series of the invention (Example 1) tends to have always lower CODcr or BOD as a water quality parameter, although it is not significant. In addition, an elimination effect based on compression flow was observed.

In Run 2 in which both the oil and phenol concentrations are increased by approximately 1.5 times, there is a clear difference in BOD treated water quality between the two series.

The comparison series (Comparative Example 1) required some time to have initial low BOD concentration value even from Run 3 in which the raw water concentration is brought back to the initial value. There was a slight difference in CODcr, oil components, and phenol, but not significant. The series of the invention (Example 1) illustrated slightly increased BOD in treated water on a day after increasing concentrations of the oil components or phenol. As such, the rate of mixture liquid returned to the first reaction chamber was increased to 10 L/d. As a result, it was observed that the BOD in treated water is lowered, and by increasing the return rate to the first reaction chamber, such effect is enhanced more.

This result was also confirmed by the determination result of respiration rate. The respiration rate of the first reaction chamber was 15 mg-O₂/(g-ss·hr) on a day before Run 2 in which the concentration is increased. However, one day after increasing the concentration, it was found to be as low as 10 mg-O₂/(g-ss·hr). In addition, on a day after increasing the return rate to the first reaction chamber, in was increased to 13 mg-O₂/(g-ss·hr).

Based on the above, it was found that a stable treatment can be achieved in the series of the invention (Example 1) by increasing the return rate to the first reaction chamber in response to an increased raw water concentration or an increased load.

After Run 3 in which the road is brought back to the initial value, the experiment of Run 4 was carried out by increasing again the concentration of the oil components and phenol by approximately 3 times.

In the comparison series (Comparative Example 1), not only BOD but also CODcr and decomposition and removal of oil components and phenol were greatly influenced, and thus concentration in treated water was significantly increased. The influence was so high that it needed a long period of time for the treated water to have the initial water quality even after the concentration was brought back to the initial value after three days. Further, since a tendency of having less discharge amount from the membrane was also observed, the revolution number of the tube pump used for discharge was increased.

Meanwhile, in the series of the invention (Example 1), weak aeration in the first reaction chamber was performed in conjunction with concentration increase so that free oil components are allowed to float and the excess sludge stored at bottom was aerated in advance for 10 min or more and introduced to the first reaction chamber. As a result, even though the concentration of oil components or phenol in flow-in water is higher than the previous run, almost no influence on the quality of treated water was observed. In addition, as there was no change in discharge amount from the membrane, no influence on flux was observed.

Meanwhile, the concentration value of the first reaction chamber was 17 mg-O₂/(g-ss·hr) as the respiration rate before increasing the concentration, but right after the concentration increase, it was lowered to 5 mg-O₂/(g-ss·hr), indicating a high inhibiting effect. The respiration rate of the second reaction chamber was between 10 mg-Oz/(g-ss·hr) and 8 mg-O₂/(g-ss·hr), indicating that there is no significant influence and the microorganisms in reaction chambers at rear stage are allowed to exhibit a stable treatment.

Based on the above results, the series of the invention (Example 1) in which the returning is divided into two levels can achieve a stable treatment in spite of concentration change or load change in waste water which contains hardly decomposing components like oil components or a biological inhibiting substances like phenol.

### Example 2

Next, one more series of the MBR treatment chamber of the invention as used in Example 1 was additionally prepared. Same amount of the acclimated sludge was added to the MBR treatment chamber and also a mesh basket added with particle activated carbon having a diameter of 3 mm was impregnated in the reaction chamber at the most downflow side, that is, the reaction chamber immediately before the membrane separation chamber, yielding Example 2 (referred to as an “active carbon added series”).

By using the series of the invention (Example 1) and the activated carbon added series of Example 2, the waste water discharge illustrated in Table 1 was continuously performed. Results of the comparison are illustrated in FIG. 10.

At the start of the treatment, the activated carbon added series (Example 2) exhibited clearly lower value than the no addition series (Example 1). This result indicates that the hardly decomposing components of the waste water are physically adsorbed onto the activated carbon. On the Day 16 and thereafter, the adsorption amount exhibited saturation, and it appears that COD removal based on physical adsorption is saturated on the Day 20. However, the COD value of the treated water of the activated carbon added series (Example 2) was continuously lower than the no addition series, clearly exhibiting the effect of addition of activated carbon. According to an observation using a microscope, it was found that the microorganisms form a thin layer and are adsorbed on the surface of activated carbon.

### Example 3

Next, one more series of the MBR treatment chamber of the invention as used in Example 1 was additionally prepared. Then, a cubic sponge carrier (length of single side: 4 mm) consisting of polyethylene short fibers was added to the first reaction chamber, in which the carrier is added in an amount of 20% of the volume capacity of the first reaction chamber. In addition, at the connection part between the first reaction chamber and the second reaction chamber, a wire mesh (that is, screen) with mesh width size of 2 mm was installed so that the carrier is prevented from entering the second reaction chamber (Example 3).

In the other series, nothing was added like Example 1.

To both the series of Example 1 and series of Example 3, sludge acclimated with waste water was added in same amount, and the continuous operation was performed under the operation condition for Run 1 of Example 1.

On the Day 20 after starting the operation, the raw water containing the oil components and phenol with the concentration increased by two times was allowed to run for 3 days, similar to Run 2 of Example 1. However, for both series, the rate of sludge returned to the first reaction chamber was not changed. The average value of the quality of the treated water is illustrated in Table 2.

TABLE 2

| | | No addition | Addition |
|---|---|---|---|
| Water quality | Raw water | series | series |
| CODcr (mg/L) | 820 | 490 | 465 |
| BOD (mg/L) | 285 | 21 | 12 |
| Oil (mg/L) | 55 | 5.5 | 2.8 |
| Phenol (mg/L) | 35 | 1.5 | 1.3 |

In the series not added with hydrophobic carrier (Example 1), both the oil component concentration and phenol concentration tend to be slightly higher than Example 1, probably due to no increase in return rate to the first reaction chamber. Meanwhile, in the series added with hydrophobic carrier (Example 3), the oil component concentration was low and both COD and BOD were low and stabilized compared to the no addition series.

When the added carrier was retrieved and pressed with hands, oil is squeezed out, which clearly indicates that the added oil components are adsorbed onto the carrier and thus the negative influence on the biological treatment activity at later stage is suppressed. When the concentrations of oil components or phenol are returned to the initial concentrations followed by the treatment, after one week, the oil adsorbed onto the carrier was not squeezed out, and thus it seems that the oil has been decomposed.

Next, half of the hydrophobic carrier was retrieved and a disc-like carrier (diameter of 5 mm and thickness of 3 mm), which has been prepared in plane form by mixing polypropylene and rayon, that are a hydrophobic fiber and a hydrophilic fiber, respectively, was added. Continuous treatment was carried out for three weeks or so using the waste water listed in Table 1. Thereafter, like the above examples, the treatment was carried out for three days while concentrations of oil components and phenol are doubled. The results are listed in Table 3.

TABLE 3

| | | No addition | Addition |
|---|---|---|---|
| Water quality | Raw water | series | series |
| CODcr (mg/L) | 850 | 501 | 485 |
| BOD (mg/L) | 305 | 18 | 5.5 |
| Oil (mg/L) | 58 | 6.2 | 2.1 |
| Phenol (mg/L) | 42 | 1.8 | 0.2 |

Although the no addition series (Example 1) had the same water quality as the previous run, the addition series added with carriers having both hydrophobic and hydrophilic property exhibited clearly lower phenol concentration and lower BOD concentration in treated water compared to the previous run. When only the hydrophobic carrier of the previous run is added, oil film was formed on surface or scum floating was observed in the first reaction chamber, but no such phenomenon was observed for a case in which carrier having both hydrophobic and hydrophilic property are added, and the oil amount squeezed out of the retrieved carrier was definitely small. The carriers were retrieved and softened by hands, and then the amount of adsorbed microorganisms was measured in terms of weight. As a result, it was 2 mg/g of carrier for the hydrophobic carrier while it was 8 mg/g of carrier for the carriers having both hydrophobic and hydrophilic property, exhibiting clearly higher microorganism adsorption amount. It is believed that the difference in microorganism adsorption amount leads to stabilization of treatment performance or increase in oil decomposition rate.

### EXPLANATIONS OF LETTERS OR NUMERALS

1 membrane separation activated sludge chamber
2 biological treatment chamber
2A first reaction chamber
2B second reaction chamber
3 separation membrane chamber
4 partition
6 waste water supply pipe
7 scum/oil skimmer
8 aeration device
9 submerced membrane unit
10 treated water drain pipe
11 returning pipe
12 sludge drain pipe
13 storage chamber
14 storage and activation chamber
15 water drain pipe
16 valve
17 valve
18 water supply pipe
20 automatic control device
21 measuring device
22 measuring device
23 sludge concentration meter
25 adsorption carrier fixing part
30 hydrophobic carrier
31 screen
32A first reaction chamber
32B second reaction chamber
33 membrane separation chamber
34 distribution chamber
35, 36, 37 gate

1. A membrane biological reactor comprising:
a biological reaction chamber in which activated sludge is present;
and a membrane separation chamber;
wherein, within the biological reaction chamber, at least one partition is installed to have a first reaction chamber, a second reaction chamber, and if necessary, an additional reaction chamber so that flow of water to be treated can form upflow and downflow path, an aeration device and a scum/oil skimmer are installed at least in the first reaction chamber, and a mixture liquid containing activated sludge is withdrawn from the membrane separation chamber, and distributed at least to the first reaction chamber and the second reaction chamber.

2. The membrane biological reactor as in claim 1, wherein flow of water to be treated forms an upflow and downflow flow path so that the flow of the water to be treated is downflow flow in the first reaction chamber while it is upflow flow in the second reaction chamber.

3. The membrane biological reactor according to claim 1, wherein, when the mixture liquid containing the activated sludge is withdrawn from the membrane separation chamber, and then distributed at least to the first reaction chamber and the second reaction chamber, the amount of mixture liquid distributed to the second reaction chamber is larger than the amount of mixture liquid distributed to the first reaction chamber.

4. The membrane biological reactor according to claim 1, wherein the returning of the mixture liquid from the separation membrane chamber is performed with an aid of air lift.

5. The membrane biological reactor according to claim 1, wherein a hydrophobic carrier is present in the first reaction chamber and also a screen is installed so that the carrier is not released into the following reaction chamber.

6. The membrane biological reactor according to claim 5, wherein the carrier is a fibrous agglomerate consisting of polyethylene (PE) or polypropylene (PP).

7. The membrane biological reactor according to claim 5, wherein a carrier manufactured by bonding or blending of a hydrophilic fabric and a hydrophobic fabric is used instead of the hydrophobic carrier.

8. The membrane biological reactor according to claim 1, wherein a carrier is installed by fixing in a reaction chamber at the downflow side of the first reaction chamber.

9. The membrane biological reactor according to claim 1, wherein fibrous activated carbon or particle granular activated carbon added in a mesh basket is impregnated in a reaction chamber at the downflow side other than the first reaction chamber.

10. A method for treatment of oil-containing waste water comprising:
supplying oil-containing waste water to be treated to a first reaction chamber;
floating up oil components and sludge adsorbed onto the oil components in the water to be treated by aeration using a aeration device in the first reaction chamber;
recovering and removing the floated components by a scum/oil skimmer;
introducing the water to be treated to a second reaction chamber using upflow and downflow path;
introducing the water to be treated into a membrane separation chamber in which the water to be treated is subjected to solid and liquid separation;
discharging a liquid passed through the membrane;
collecting a mixture liquid containing activated sludge not passed through the membrane from the membrane separation chamber;
distributing and returning the mixture liquid containing activated sludge at least to the first reaction chamber and the second reaction chamber,
wherein the method uses the membrane biological reactor having a biological reaction chamber in which activated sludge is present, and a membrane separation chamber, in which the membrane biological reactor has a configuration that, within the biological reaction chamber, at least one partition is installed to have a first reaction chamber, a second reaction chamber, and if necessary, an additional reaction chamber so that flow of water to be treated can form upflow and downflow flow path and an aeration device and a scum/oil skimmer are installed at least in the first reaction chamber.

11. The method for treatment of oil-containing waste water according to claim 10, wherein the mixture liquid containing the activated sludge in the first reaction chamber or the mixture liquid containing the activated sludge in the membrane separation chamber is withdrawn, aerated in a storage batch equipped with an aeration device with a retention time of at least for 10 min, and supplied to the first reaction chamber.

12. The method for treatment of oil-containing waste water according to claim 10, wherein floating of the oil components in the first reaction chamber is promoted and also floating of the activated sludge adsorbed with oil components is promoted so that the floated components are collected and removed by the scum/oil skimmer by stopping the aeration device in the first reaction chamber or by controlling the aeration amount to the level at which sludge in the mixture liquid in the first reaction chamber can stay or float up.
